(19) United States
(12) Patent Application Publication
(10) Pub. No.: US 2016/0109981 A1
(43) Pub. Date: Apr. 21, 2016

(54) IN-CELL TOUCH PANEL AND TRACE LAYOUT THEREOF

(71) Applicant: Raydium Semiconductor Corporation, Hsinchu (TW)

(72) Inventors: Yi-Ying Lin, Hualien City (TW); Chang-Ching Chiang, Taichung City (TW); Kun-Pei Lee, Zhunan Township (TW)

(21) Appl. No.: 14/885,290

(22) Filed: Oct. 16, 2015

Related U.S. Application Data
(60) Provisional application No. 62/162,238, filed on May 15, 2015.
(60) Provisional application No. 62/158,242, filed on May 7, 2015.
(60) Provisional application No. 62/065,317, filed on Oct. 17, 2014.

(51) Int. Cl. G06F 3/044; G09G 3/36; G06F 3/041

(52) U.S. Cl. CPC G06F 3/044; G06F 3/0412; G06F 3/0416; G09G 3/36; G06F 2203/04112; G06F 2203/04111

(57) ABSTRACT

An in-cell touch panel and its trace layout are disclosed. The in-cell touch panel includes a plurality of pixels. Each pixel has a laminated structure bottom-up including a substrate, a TFT layer, a liquid crystal layer, a color filter layer, and a glass layer. The TFT layer is disposed on the substrate. A first conductive layer and a common electrode are disposed in the TFT layer. The first conductive layer is aligned in mesh type. The liquid crystal layer is disposed on the TFT layer. The color filter layer is disposed on the liquid crystal layer. The glass layer is disposed on the color filter layer. The design of touch sensing electrodes and their trace layout in the in-cell touch panel of the application is simple and it can effectively reduce cost and reduce the RC loading of a common electrode.

### BACKGROUND OF THE INVENTION

1. Field of the Invention

This invention relates to a touch panel, especially to an in-cell touch panel and trace layout thereof.

2. Description of the Related Art

Please refer to FIG. 1. FIG. 1 illustrates a laminated structure of a conventional on-cell capacitive touch panel. As shown in FIG. 1, the laminated structure 1 of the conventional on-cell capacitive touch panel includes a substrate 10, a thin-film transistor layer 11, a liquid crystal layer 12, a color filtering layer 13, a glass layer 14, a touch sensing layer 15, a polarizer 16, an adhesive 17, and top lens 18.

From FIG. 1, it can be found that the touch sensing layer 15 of the on-cell capacitive touch panel is disposed above the glass layer 14; that is to say, the touch sensing layer 15 is disposed out of the liquid crystal display module of the on-cell capacitive touch panel. Compared to the conventional one glass solution (OGS), the on-cell capacitive touch panel can achieve thinner touch panel design; however, the on-cell capacitive touch panel cannot meet the thinnest thickness requirement of the novel portable electronic products such as mobile phones, tablet PCs, and notebooks.

Therefore, the invention provides an in-cell mutual-capacitive touch panel and trace layout thereof to solve the above-mentioned problems.

### SUMMARY OF THE INVENTION

A preferred embodiment of the invention is an in-cell mutual-capacitive touch panel. In this embodiment, the in-cell mutual-capacitive touch panel includes a plurality of pixels. A laminated structure of each pixel includes a substrate, a thin-film transistor layer, a liquid crystal layer, a color filtering layer, and a glass layer. The thin-film transistor layer is disposed above the substrate. A first conductive layer and a common electrode are disposed in the thin-film transistor layer, and the first conductive layer is arranged in mesh type. The liquid crystal layer is disposed above the thin-film transistor layer. The color filtering layer is disposed above the liquid crystal layer. The glass layer is disposed above the color filtering layer.

In an embodiment, the in-cell touch panel is an in-cell mutual-capacitive touch panel, and touch electrodes of the in-cell mutual-capacitive touch panel are formed by the first conductive layer which is arranged in mesh type, the touch electrodes comprise a first direction electrode and a second direction electrode.

In an embodiment, the first direction electrode and the second direction electrode of the touch electrodes are interlaced each other to increase an area of an effective touch region.

In an embodiment, area division of the touch electrodes is determined according to connection or disconnection of the first conductive layer.

In an embodiment, a part of the first conductive layer not forming the touch electrodes is disposed in a vacancy region between the touch electrodes to connect with the common electrode.

In an embodiment, the first conductive layer is formed after the common electrode.

In an embodiment, the first conductive layer is formed before the common electrode.

In an embodiment, the color filtering layer comprises a color filter and a black matrix resist and the black matrix resist has good light resistance, and the first conductive layer is disposed under the black matrix resist.

In an embodiment, a second conductive layer is also disposed in the thin-film transistor layer and the second conductive layer is formed before the first conductive layer and the common electrode.

In an embodiment, the second conductive layer and the common electrode are connected to decrease resistance.

In an embodiment, the second conductive layer and a gate electrode of the thin-film transistor layer are formed simultaneously.

In an embodiment, the gate electrode of the thin-film transistor layer is arranged adjacent to another gate electrode.

In an embodiment, the second conductive layer and the first conductive layer are overlapped and connected in parallel to decrease resistance.

In an embodiment, the second conductive layer and a source electrode and a drain electrode of the thin-film transistor layer are formed simultaneously.

In an embodiment, when the laminated structure has a half source driving (HSD) structure, the laminated structure has an additional space which is originally occupied by a source line.

In an embodiment, the second conductive layer is disposed in the additional space to be traces of the touch electrodes.

In an embodiment, the second conductive layer is disposed in the additional space to connect with the common electrode to decrease resistance.

In an embodiment, the traces of the touch electrode are arranged in a centralized way or a uniform way.

In an embodiment, at least one multi-function electrode (MFL) is disposed between the first direction electrode and the second direction electrode of the touch electrodes.

In an embodiment, a shape of the touch electrode is arbitrary geometries.

In an embodiment, an edge of the touch electrode is irregular.

In an embodiment, when the in-cell touch panel is operated in a touch mode, the common electrode is switched to a floating voltage level or provided a touch-related signal.

In an embodiment, when the in-cell touch panel is operated in a touch mode, a source line is switched to a floating voltage level or provided a touch-related signal.

In an embodiment, a touch mode and a display mode of the in-cell touch panel are driven in a time-sharing way, and the in-cell touch panel is operated in the touch mode during a blanking interval of a display period of the in-cell touch panel.

In an embodiment, the blanking interval comprises at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval comprises the vertical blanking interval.

In an embodiment, the first direction electrode is divided into electrode regions and vertically interlaced with the second direction electrode.

In an embodiment, the in-cell touch panel further includes a driving chip disposed out of an active area (AA) of the in-cell touch panel.

In an embodiment, the traces of different electrode regions of the first direction electrode are connected to the driving chip independently.

In an embodiment, traces of at least two electrode regions of the first direction electrode are connected out of the active area of the in-cell touch panel and then connected to the driving chip.

In an embodiment, the traces of the at least two electrode regions of the first direction electrode are connected out of the active area of the in-cell touch panel by an original conductive layer of the thin-film transistor layer.

In an embodiment, the traces of the at least two electrode regions of the first direction electrode are connected out of the active area of the in-cell touch panel and then connected to the driving chip in a form of one group or multiple groups.

Compared to the prior arts, the in-cell touch panel and its trace layout of the invention have following advantages:

(1) Designs of the touch electrodes and their traces in the in-cell touch panel of the invention are very simple, and the cost of the in-cell touch panel of the invention can be reduced.

(2) The aperture ratio of the LCD touch panel will not be affected by the novel trace layout method of the invention.

(3) The RC loading of the common electrode can be reduced.

(4) When the in-cell touch panel is operated in the touch mode, the common electrode is controlled simultaneously to reduce the entire RC loading of the in-cell touch panel.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the laminated structure of the conventional on-cell capacitive touch panel.

FIG. 2A illustrates a schematic diagram of the laminated structure of the in-cell capacitive touch panel in a first preferred embodiment of the invention.

FIG. 2B illustrates a schematic diagram of the pixel design of the first preferred embodiment.

FIG. 3A illustrates a schematic diagram of the laminated structure of the in-cell capacitive touch panel in a second preferred embodiment of the invention.

FIG. 3B illustrates a schematic diagram of the pixel design of the second preferred embodiment.

FIG. 4A illustrates a schematic diagram of the laminated structure of the in-cell capacitive touch panel in a third preferred embodiment of the invention.

FIG. 4B illustrates a schematic diagram of the pixel design of the third preferred embodiment.

FIG. 5A illustrates a schematic diagram of the laminated structure of the in-cell capacitive touch panel in a fourth preferred embodiment of the invention.

FIG. 5B illustrates a schematic diagram of the pixel design of the fourth preferred embodiment.

FIG. 6 illustrates a schematic diagram of the pixel design applied to the HSD structure in a fifth preferred embodiment.

FIG. 7A and FIG. 7B illustrate schematic diagrams of the in-cell mutual-capacitive mesh-type touch electrode design including multi-function electrodes (MFLs).

FIG. 8A and FIG. 8B illustrate schematic diagrams of straight edges and non-straight edges of the in-cell mutual-capacitive mesh-type touch electrodes.

FIG. 9A and FIG. 9B illustrate a schematic diagram of the in-cell mutual-capacitive touch panel having multiple common electrode regions and a timing diagram of the signals when the in-cell mutual-capacitive touch panel is operated in the touch mode and the display mode respectively.

FIG. 10A and FIG. 10B illustrate a schematic diagram of the in-cell mutual-capacitive touch panel having a single common electrode region and a timing diagram of the signals when the in-cell mutual-capacitive touch panel is operated in the touch mode and the display mode respectively.

FIG. 11A illustrates a timing diagram of the touch mode and the display mode of the in-cell mutual-capacitive touch panel being driven in a time-sharing way.

FIG. 11B illustrates a schematic diagram of the vertical blanking interval (VBI), the horizontal blanking interval (HBI), and the long horizontal blanking interval respectively.

FIG. 12A, FIG. 12B, and FIG. 12C illustrate schematic diagrams of different trace configurations of the first direction touch electrodes and the second direction touch electrodes out of the active area of the in-cell mutual-capacitive touch panel respectively.

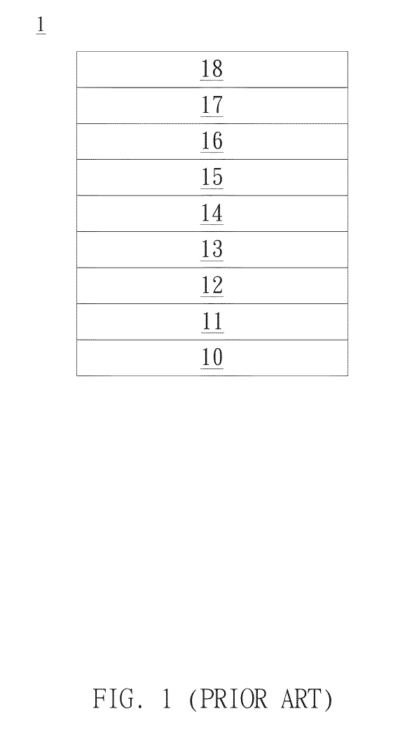

### DETAILED DESCRIPTION

A main scope of the invention is to provide a new design of the in-cell mutual-capacitive touch panel to effectively reduce the resistance and parasitic capacitance of the touch display panel and to realize a single-layer in-cell mutual-capacitive touch component under a condition of generating minimum effects on the LCD display apparatus. The main features of the in-cell mutual-capacitive touch panel of the invention include but not limited the following features:

(1) using a first conductive layer to form touch electrodes in mesh-type;

(2) the touch electrodes in mesh-type are disposed under the black matrix (BM) of the color-filtering layer;

(3) the touch electrodes in mesh-type include not only the driving electrodes (TX) and the sensing electrodes (RX), but also the multi-function electrodes (MFL) based on practical needs;

(4) the touch electrodes in mesh-type is configured in a single layer and the driving electrodes (TX) and the sensing electrodes (RX) can be interlaced to increase the effective touch sensing region and enhance the sensitivity of touch sensing;

(5) the first conductive layer is used to form the touch electrodes in mesh-type and a part of the first conductive layer not forming the touch electrodes can be electrically connected with the common electrode (VCOM) to reduce the RC loading of the common electrode;

(6) when the in-cell mutual-capacitive touch panel is operated in the touch mode, the common electrode can be switched to a floating voltage level or provided a touch-related signal to reduce the parasitic capacitance when touch sensing.

A preferred embodiment of the invention is an in-cell mutual-capacitive touch panel. In practical applications, the in-cell mutual-capacitive touch panel can achieve thinnest touch panel design; therefore, it can be widely used in portable electronic products such as mobile phones, tablet PCs, and notebooks.

In this embodiment, the in-cell mutual-capacitive touch panel can be suitable for displays using in-plane switching liquid crystal (IPS) technology, fringe field switching (FFS) technology, or advanced hyper-viewing angle (AHVA) technology, but not limited to these cases.

In general, the most popular capacitive touch sensing technology in nowadays should be the projected capacitive touch sensing technology including a mutual-capacitive type and a self-capacitive type. As to the mutual-capacitive touch sensing technology, when a touch occurs, capacitive coupling will be generated between two electrode layers adjacent to the touch point, and the capacitance change between the two electrode layers will be used to determine the touch point. As to the self-capacitive touch sensing technology, when a touch occurs, capacitive coupling will be generated between the touch item and the electrode, and the capacitance change of the electrode will be used to determine the touch point.

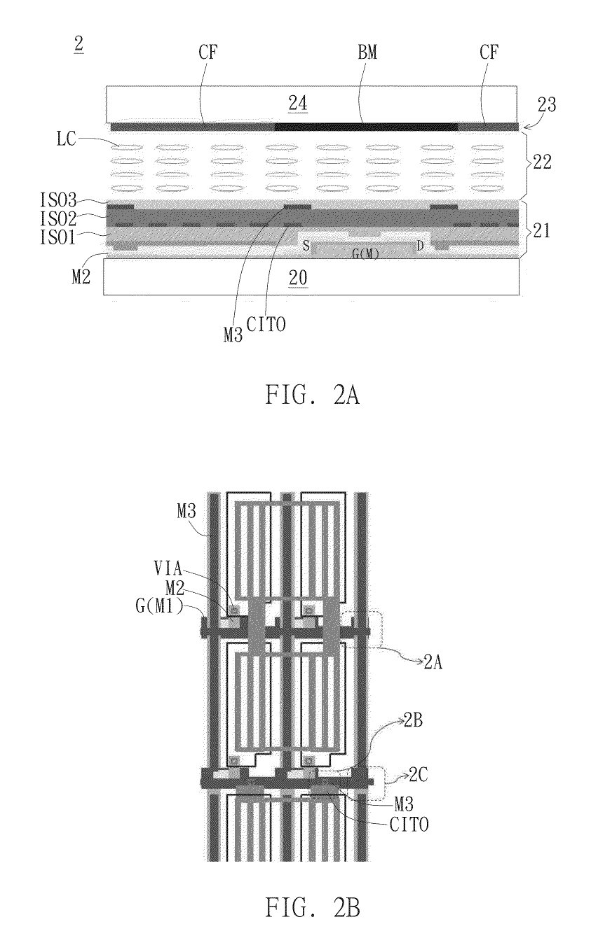

At first, please refer to FIG. 2A and FIG. 2B. FIG. 2A illustrates a schematic diagram of the laminated structure 2 of the in-cell mutual-capacitive touch panel in the embodiment of the invention. FIG. 2B illustrates a schematic diagram of the pixel design of this embodiment. It should be noticed that this embodiment uses an ordinary TFT-LCD panel to show the laminated structure of the in-cell mutual-capacitive touch panel of the invention; however, when the panel is actually designed, there will be different designs based on different kinds of panel and their different characteristics. For example, if the invention is used in a panel having the color filter on array (COA) structure, the aperture ratio of the in-cell mutual-capacitive touch panel can be even increased.

As shown in FIG. 2A, in an embodiment, the laminated structure 2 of the in-cell capacitive touch panel includes a substrate 20, a thin-film transistor (TFT) layer 21, a liquid crystal layer 22, a color filtering layer 23, a glass layer 24. The color filtering layer 23 includes a color filter CF and a black matrix resist BM. The black matrix resist BM has good light resistance and it can be used in the color filtering layer 23 to separate three different color filters including a red (R) color filter, a green (G) color filter, and a blue (b) color filter, but not limited to this.

In this embodiment, a first conductive layer M3 and a common electrode CITO are disposed in the TFT layer 21. The first conductive layer M3 is formed after the common electrode CITO, and the first conductive layer M3 is arranged in mesh-type to form a single-layer touch electrode pattern. In detail, the common electrode CITO is formed above the isolation layer ISO1 and then the isolation layer ISO2 is formed above the common electrode CITO, and then the first conductive layer M3 is formed above the isolation layer ISO2 and the isolation layer ISO3 is formed above the first conductive layer M3.

It should be noticed that the position that the first conductive layer M3 is disposed in the TFT layer 21 corresponds to the black matrix resist BM of the color filtering layer 23 disposed above, so that the first conductive layer M3 can be shielded by the black matrix resist BM having good light resistance, but not limited to this.

In addition, a second conductive layer M2 is disposed in the TFT layer 21. It should be noticed that the second conductive layer M2 can be any original conductive layers in the TFT layer 21; therefore, the manufacturing process will not become more complicated and the aperture ratio of the in-cell mutual-capacitive touch panel will not be decreased.

In this embodiment, the second conductive layer M2 is formed before the first conductive layer M3 and the common electrode CITO. For example, the second conductive layer M2 and the source electrode (S) and the drain electrode (D) of the TFT layer 21 can be formed by the same material in the same manufacturing process, or the second conductive layer M2 and the gate electrode (G) of the TFT layer 21 can be formed by the same material in the same manufacturing process, but not limited to this. In fact, the second conductive layer M2 can be formed by any conductive materials and it can be arranged horizontally, vertically, or in mesh-type.

In practical applications, the second conductive layer M2 can be used as traces of the single-layer mesh-type touch electrodes formed by the first conductive layer M3; the second conductive layer M2 can be also used as traces connecting with the common electrode CITO to decrease the resistance and loading of the common electrode CITO; the second conductive layer M2 and the first conductive layer M3 can be overlapped and connected in parallel to decrease resistance.

Next, as shown in FIG. 2B, in the pixel design of this embodiment, the connection or disconnection of the first conductive layer M3 can be used to divide the touch electrodes into different touch electrode regions. For example, since the upper part and the lower part of the first conductive layer M3 are connected in the dotted-line range 2A in FIG. 2B, the upper pixel and the lower pixel in the dotted-line range 2A will belong to the same touch electrode region; on the contrary, since the upper part and the lower part of the first conductive layer M3 are disconnected in the dotted-line range 2C in FIG. 2B, the upper pixel and the lower pixel in the dotted-line range 2C will belong to different touch electrode regions respectively.

In addition, as shown in the dotted-line range 2B in FIG. 2B, a part of the first conductive layer M3 not forming the touch electrodes can be also disposed in the vacancy region between the touch electrodes to electrically connect with the common electrode CITO disposed lower through the via VIA.

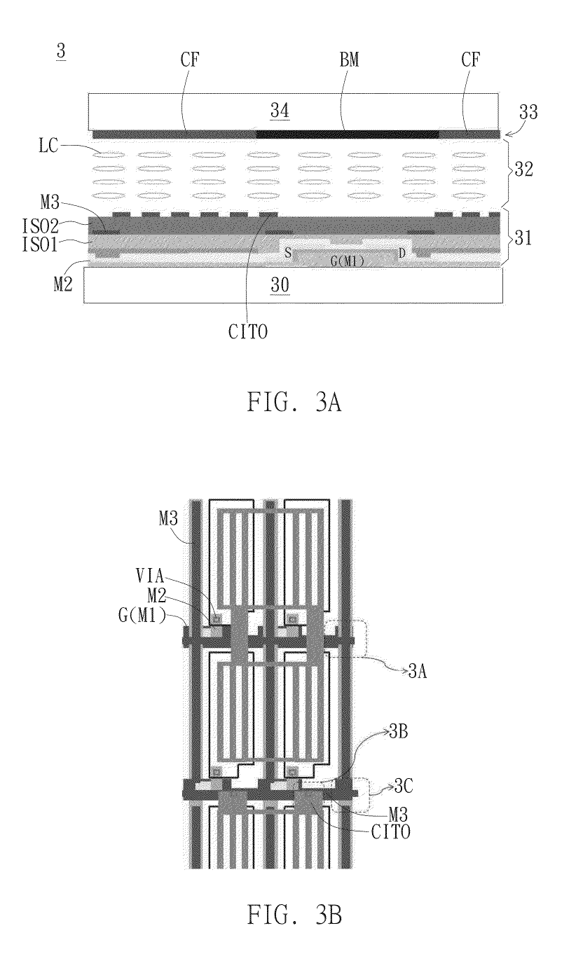

Then, please refer to FIG. 3A and FIG. 3B. FIG. 3A illustrates a schematic diagram of the laminated structure 3 of the in-cell capacitive touch panel in a second preferred embodiment of the invention. FIG. 3B illustrates a schematic diagram of the pixel design of the second preferred embodiment.

The difference between the second preferred embodiment and the first preferred embodiment is only that the first conductive layer M3 of the second preferred embodiment is formed before the common electrode CITO. In detail, the first conductive layer M3 is formed above the isolation layer ISO1, and then the isolation layer ISO2 is formed above the first conductive layer M3, and then the common electrode CITO is formed above the isolation layer ISO2.

As shown in FIG. 3B, in the pixel design of this embodiment, the connection or disconnection of the first conductive layer M3 can be also used to divide the touch electrodes into different touch electrode regions. For example, since the upper part and the lower part of the first conductive layer M3 are connected in the dotted-line range 3A in FIG. 3B, the upper pixel and the lower pixel in the dotted-line range 3A will belong to the same touch electrode region; on the contrary, since the upper part and the lower part of the first conductive layer M3 are disconnected in the dotted-line range 3C in FIG. 3B, the upper pixel and the lower pixel in the dotted-line range 3C will belong to different touch electrode regions respectively. In addition, as shown in the dotted-line range 3B in FIG. 3B, a part of the first conductive layer M3 not forming the touch electrodes can be also disposed in the vacancy region between the touch electrodes to electrically connect with the common electrode CITO disposed above through the via VIA.

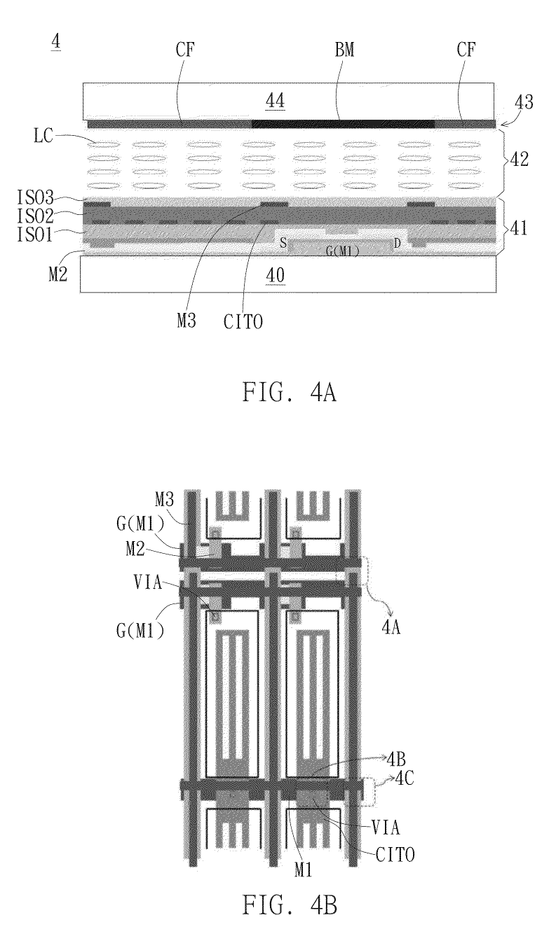

Afterward, please refer to FIG. 4A and FIG. 4B. FIG. 4A illustrates a schematic diagram of the laminated structure 4 of the in-cell capacitive touch panel in a third preferred embodiment of the invention. FIG. 4B illustrates a schematic diagram of the pixel design of the third preferred embodiment. It should be noticed that the laminated structure 4 of the in-cell capacitive touch panel shown in FIG. 4A is similar to the laminated structure 2 of the in-cell capacitive touch panel shown in FIG. 2A, the details of the laminated structure 4 of the in-cell capacitive touch panel of FIG. 4A will not be introduced again here.

As shown in FIG. 4B, in the pixel design of this embodiment, two gate lines G formed by another conductive layer M1 can be adjacently arranged to reduce the width of the black matrix resist BM of the color filtering layer 43 disposed above. In addition, because this configuration is used, the conductive layer (e.g., M1) other than the touch electrodes (the first conductive layer M3) can be disposed in the vacancy space at another end of the pixel and electrically connected with the common electrode CITO disposed above through the via VIA to reduce the resistance and loading of the common electrode CITO, as shown in the dot-line range 4B of FIG. 4B.

Similarly, the connection or disconnection of the first conductive layer M3 can be also used to divide the touch electrodes into different touch electrode regions in this embodiment. For example, since the upper part and the lower part of the first conductive layer M3 are connected in the dotted-line range 4C in FIG. 4B, the upper pixel and the lower pixel in the dotted-line range 4C will belong to the same touch electrode region; on the contrary, since the upper part and the lower part of the first conductive layer M3 are disconnected in the dotted-line range 4A in FIG. 4B, the upper pixel and the lower pixel in the dotted-line range 4A will belong to different touch electrode regions respectively.

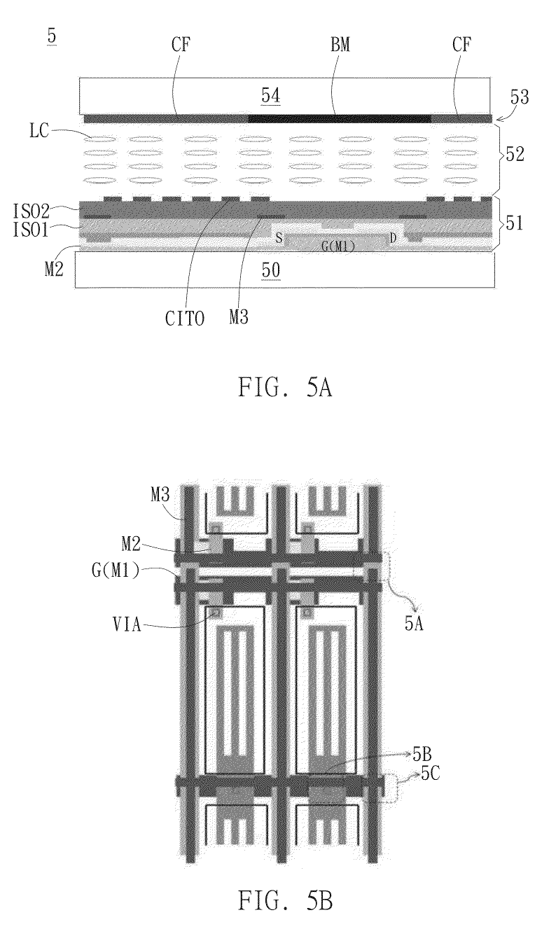

Then, please refer to FIG. 5A and FIG. 5B. FIG. 5A illustrates a schematic diagram of the laminated structure of the in-cell capacitive touch panel in a fourth preferred embodiment of the invention. FIG. 5B illustrates a schematic diagram of the pixel design of the fourth preferred embodiment. It should be noticed that the laminated structure 5 of the in-cell capacitive touch panel shown in FIG. 5A is similar to the laminated structure 3 of the in-cell capacitive touch panel shown in FIG. 3A, the details of the laminated structure 5 of the in-cell capacitive touch panel of FIG. 5A will not be introduced again here.

The difference between the fourth preferred embodiment and the third preferred embodiment is only that the first conductive layer M3 of the third preferred embodiment is formed after the common electrode CITO, while the first conductive layer M3 of the fourth preferred embodiment is formed before the common electrode CITO.

It should be noticed that, as shown in FIG. 5B, in the pixel design of this embodiment, two gate lines G formed by another conductive layer M1 can be adjacently arranged to reduce the width of the black matrix resist BM of the color filtering layer 53 disposed above. In addition, because this configuration is used, the conductive layer (e.g., M1) other than the touch electrodes (the first conductive layer M3) can be disposed in the vacancy space at another end of the pixel and electrically connected with the common electrode CITO disposed above through the via VIA to reduce the resistance and loading of the common electrode CITO, as shown in the dot-line range 5B of FIG. 5B.

Similarly, the connection or disconnection of the first conductive layer M3 can be also used to divide the touch electrodes into different touch electrode regions in this embodiment. For example, since the upper part and the lower part of the first conductive layer M3 are connected in the dotted-line range 5C in FIG. 5B, the upper pixel and the lower pixel in the dotted-line range 5C will belong to the same touch electrode region; on the contrary, since the upper part and the lower part of the first conductive layer M3 are disconnected in the dotted-line range 5A in FIG. 5B, the upper pixel and the lower pixel in the dotted-line range 5A will belong to different touch electrode regions respectively.

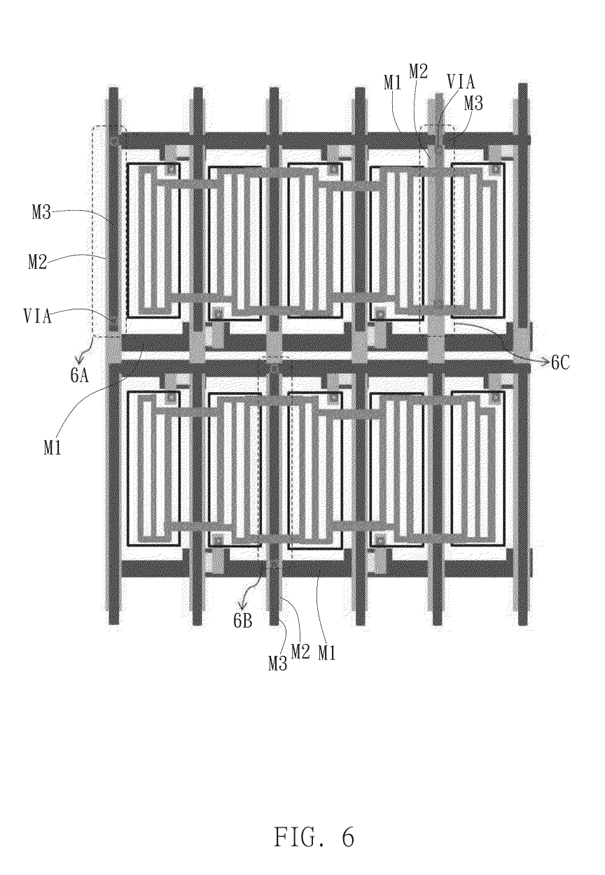

Please refer to FIG. 6. FIG. 6 illustrates a schematic diagram of the pixel design applied to the HSD structure in a fifth preferred embodiment.

As shown in FIG. 6, the connection or disconnection of the first conductive layer M3 can be also used to divide the touch electrodes into different touch electrode regions in this embodiment. Please refer to the dotted-line ranges 6A and 6B, since there is an additional space which is originally occupied by a source line, the conductive layer (e.g., M2) other than the touch electrodes (the first conductive layer M3) can be disposed in the additional space to be traces of the touch electrodes. With that, the area of the touch non-effective regions caused by the traces can be decreased to enhance the linear performance. In addition, as shown in the dotted-line range 6C of FIG. 6, the conductive layer (e.g., M2) other than the touch electrodes (the first conductive layer M3) can be disposed in the additional space to be traces electrically connected with the common electrode CITO disposed above through the via VIA to reduce the resistance of the common electrode CITO.

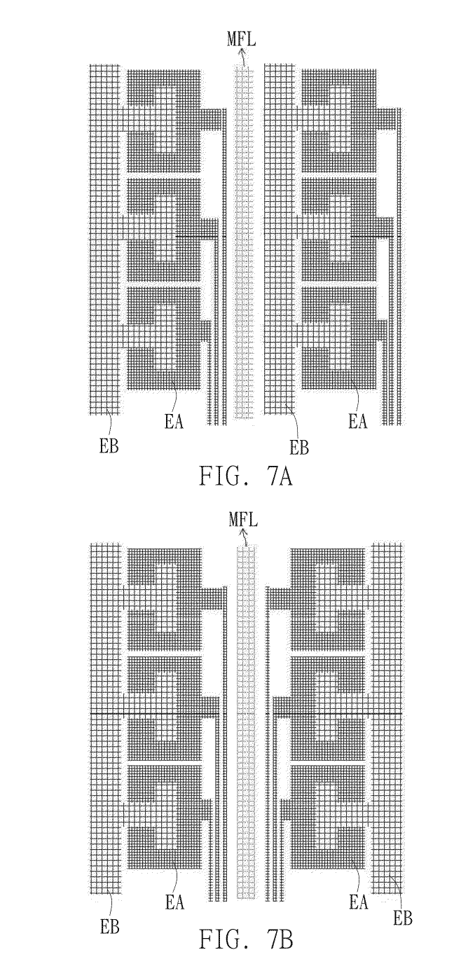

Please refer to FIG. 7A and FIG. 7B. FIG. 7A and FIG. 7B illustrate schematic diagrams of the in-cell mutual-capacitive mesh-type touch electrode design including multi-function electrodes (MFLs). As shown in FIG. 7A and FIG. 7B, the touch electrodes EA and EB can be a driving electrode (TX) and a sensing electrode (RX) respectively, and they are mesh-type patterned single-layer touch electrodes formed by the first conductive layer M3.

In practical applications, multi-function electrodes (MFLs) can be disposed between the driving electrodes (TXs) and the sensing electrodes (RXs); the multi-function electrodes (MFLs) are mesh-type patterned single-layer touch electrodes formed by the first conductive layer M3.

In addition, in the in-cell mutual-capacitive mesh-type touch electrode design of the invention, the first conductive layer properly disposed in the vacancies between the touch electrodes can be included or not, and it can be used to electrically connected with the common electrode to decrease its resistance. As to the traces formed by the second conductive layer, they can be arranged in a centralized way or a uniform way based on practical needs without any specific limitations.

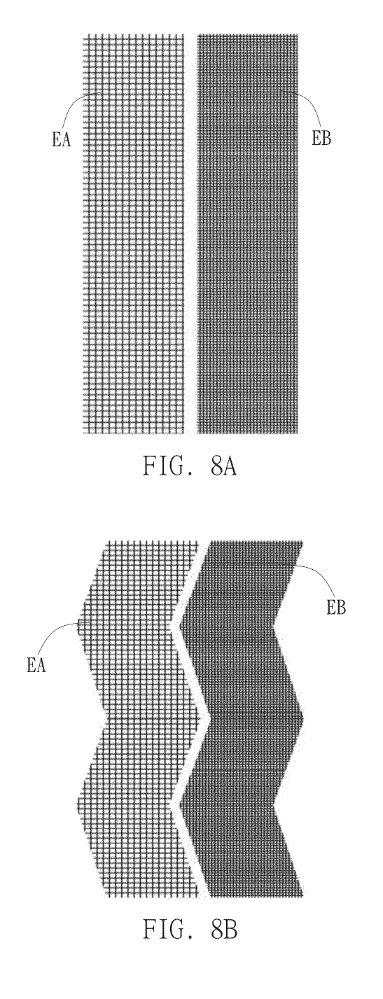

It should be mentioned that the laminated structure of the in-cell mutual-capacitive touch panel of the invention can realize different kinds of single-layer touch electrode patterns. In fact, the shapes of the touch electrodes EA and EB can be arbitrary geometries based on practical needs; for example, regular shapes or irregular shapes. And, the shapes of the edges of the touch electrodes EA and EB can be straight as shown in FIG. 8A or irregular shapes as shown in FIG. 8 without any specific limitations.

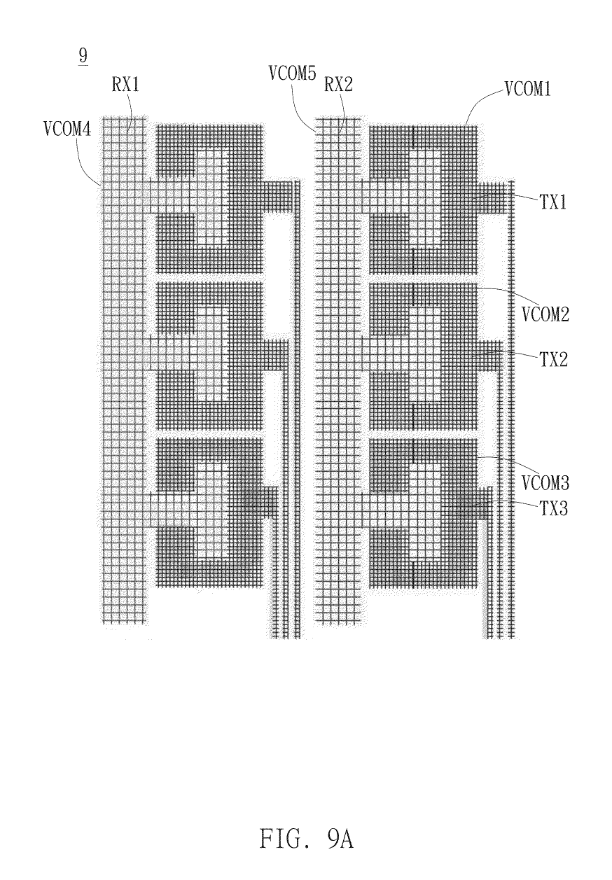

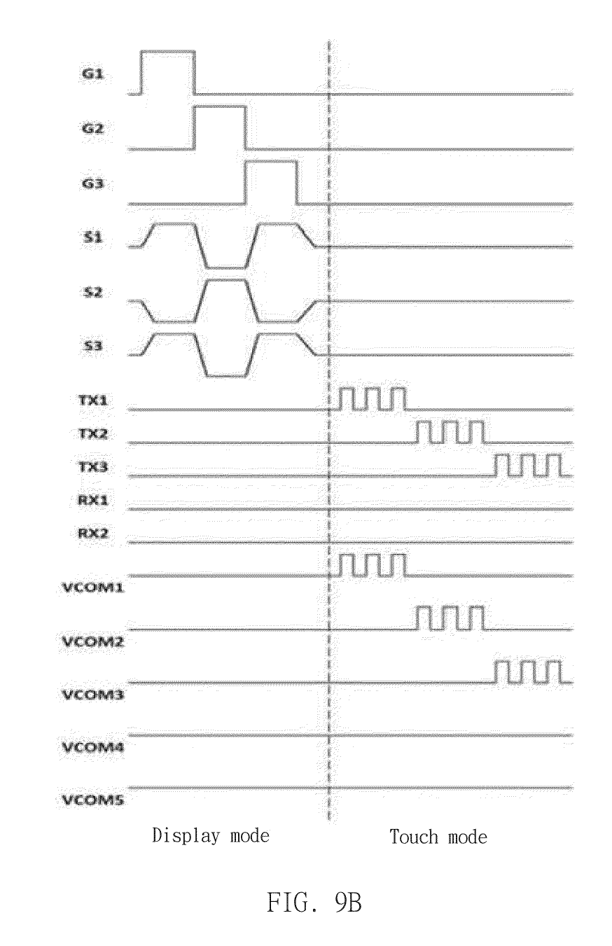

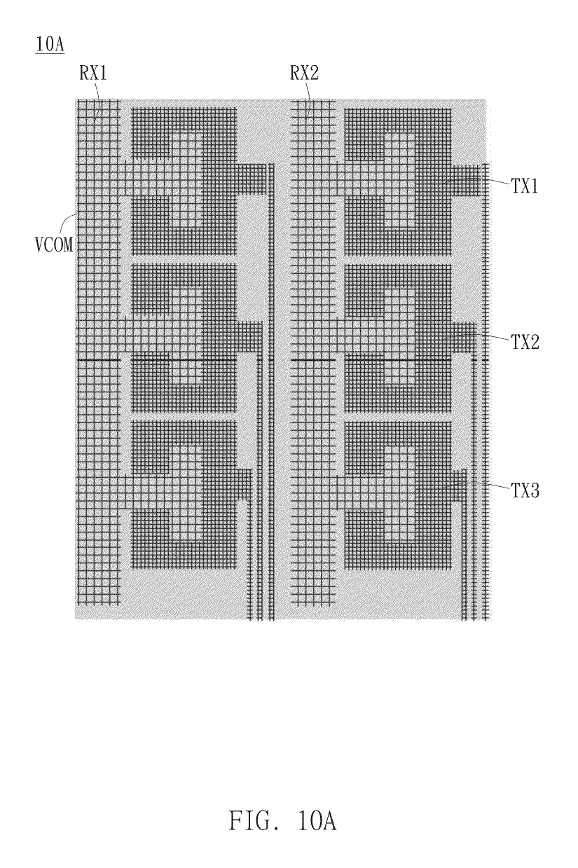

Then, please refer to FIG. 9A and FIG. 9B. FIG. 9A and FIG. 9B illustrate a schematic diagram of the in-cell mutual-capacitive touch panel 9 having multiple common electrode regions and a timing diagram of the signals when the in-cell mutual-capacitive touch panel 9 is operated in the touch mode and the display mode respectively.

As shown in FIG. 9A, the common electrode of the in-cell mutual-capacitive touch panel 9 can be disconnected at proper positions to form five common electrode regions VCOM1˜VCOM5. Wherein, the common electrode regions VCOM1˜VCOM3 of the common electrode are parts overlapping the driving electrodes TX1˜TX3; the common electrode regions VCOM4˜VCOM5 of the common electrode are parts overlapping the sensing electrodes RX1˜RX2. When the in-cell mutual-capacitive touch panel 9 is operated in the touch mode, different common electrode regions VCOM1˜VCOM5 can receive different signals respectively, for example, touch-related diving signals or fixed voltage signals, but not limited to this.

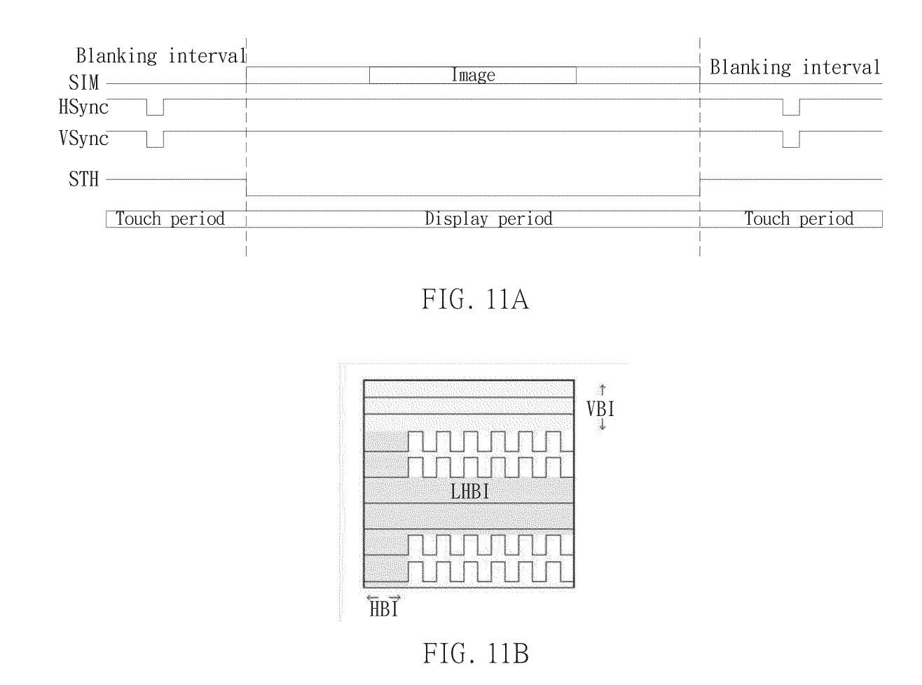

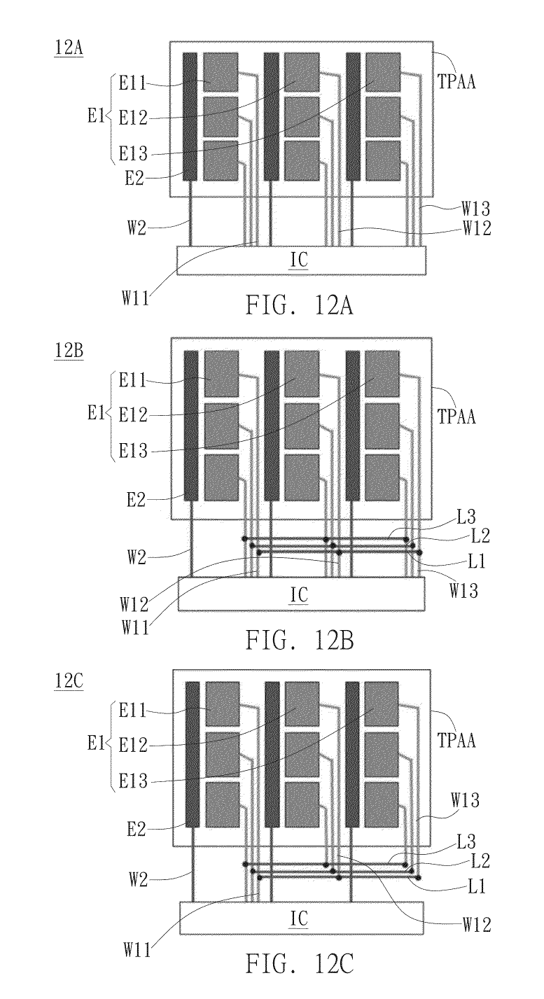

As shown in FIG. 9B, the in-cell mutual-capacitive touch panel 9 can be operated in the display mode and the touch mode at different times respectively; in other words, the touch mode and the display mode of the in-cell mutual-capacitive touch panel 9 are driven in a time-sharing way. Please also refer to FIG. 11A, it should be noticed that the in-cell mutual-capacitive touch panel 9 uses the blanking interval in the image signal SIM to output the touch driving signal STH and operated in the touch mode. The in-cell mutual-capacitive touch panel 9 will perform touch sensing at non-display timing (namely the blanking interval).

When the in-cell mutual-capacitive touch panel 9 is operated in the display mode, the gate driver and the source driver will output the gate driving signals G1˜G3 and the source driving signals S11˜S3 respectively to drive the pixels of the in-cell mutual-capacitive touch panel 9 to display images; when the in-cell mutual-capacitive touch panel 9 is operated in the touch mode, the common electrode regions VCOM1˜VCOM3 overlapping the driving electrodes TX1˜TX3 will be provided touch-related driving signals of the driving electrodes TX1˜TX3, and the common electrode regions VCOM4˜VCOM5 overlapping the sensing electrodes RX1˜RX2 will be provided a fixed voltage signal. And, the source line can be switched to a floating voltage level or partially switched to a signal having the same phase, the same amplitude, and the same frequency with the touch signal.

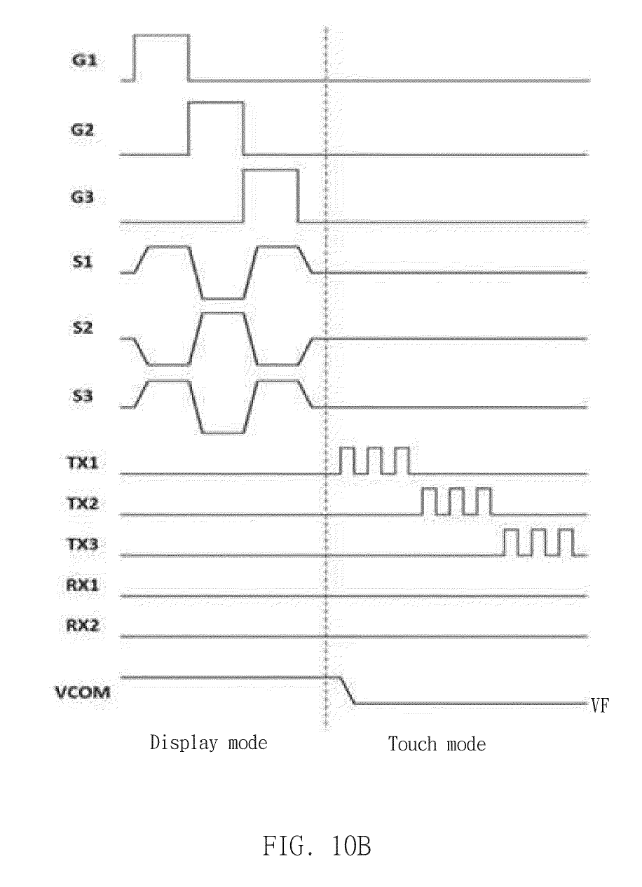

Then, please refer to FIG. 10A and FIG. 10B. FIG. 10A and FIG. 10B illustrate a schematic diagram of the in-cell mutual-capacitive touch panel 10A having a single common electrode region and a timing diagram of the signals when the in-cell mutual-capacitive touch panel is operated in the touch mode and the display mode respectively.

As shown in FIG. 10A, the common electrode VCOM of this embodiment is disposed on an entire region overlapping the driving electrodes TX1˜TX3 and the sensing electrodes RX1˜RX2 at the same time.

As shown in FIG. 10B, the in-cell mutual-capacitive touch panel 10A can be operated in the display mode and the touch mode at different times respectively; in other words, the touch mode and the display mode of the in-cell mutual-capacitive touch panel 10A are driven in a time-sharing way. Please also refer to FIG. 11A, it should be noticed that the in-cell mutual-capacitive touch panel 10A uses the blanking interval in the image signal SIM to output the touch driving signal STH and operated in the touch mode. The in-cell mutual-capacitive touch panel 10A will perform touch sensing at non-display timing (namely the blanking interval).

When the in-cell mutual-capacitive touch panel 10A is operated in the display mode, the gate driver and the source driver will output the gate driving signals G1˜G3 and the source driving signals S1˜S3 respectively to drive the pixels of the in-cell mutual-capacitive touch panel 10A to display images; when the in-cell mutual-capacitive touch panel 10A is operated in the touch mode, the common electrode region VCOM will be switched to a floating voltage level VF. And, the source line can be switched to a floating voltage level or partially switched to a signal having the same phase, the same amplitude, and the same frequency with the touch signal.

Please refer to FIG. 11B. FIG. 11B illustrates a schematic diagram of the vertical blanking interval (VBI), the horizontal blanking interval (HBI), and the long horizontal blanking interval respectively. In practical applications, the in-cell mutual-capacitive touch panel can use one or more kinds of blanking intervals based on different driving ways. As shown in FIG. 11B, the blanking intervals can include at least one of the vertical blanking interval VBI, the horizontal blanking interval HBI, and the long horizontal blanking interval LHBI. Wherein, the time length of the long horizontal blanking interval LHBI is equal to or larger than that of the horizontal blanking interval HBI. The long horizontal blanking interval LHBI can be obtained by redistributing a plurality of horizontal blanking intervals HBI or the long horizontal blanking interval LHBI includes the vertical blanking interval VBI.

Please refer to FIG. 12A, FIG. 12B, and FIG. 12C. FIG. 12A, FIG. 12B, and FIG. 12C illustrate schematic diagrams of different trace configurations of the first direction touch electrodes and the second direction touch electrodes out of the active area of the in-cell mutual-capacitive touch panel respectively.

As shown in FIG. 12A, in an embodiment, the touch electrodes of the in-cell mutual-capacitive touch panel 12A includes first direction electrodes E1 and second direction electrodes E2, and the first direction electrodes E1 and the second direction electrodes E2 are interlaced to increase the area of the effective touch regions. Wherein, each of the first direction electrodes E1 is divided into electrode regions E11˜E13 and vertically interlaced with the second direction electrodes E2.

It should be noticed that the traces W11˜W13 of the different electrode regions E11˜E13 of the first direction electrode E1 are connected to the control chip IC out of the active area TPAA of the in-cell mutual-capacitive touch panel 12A independently. And, each second direction electrode E2 is connected to the control chip IC through its independent trace W2, and the touch signals are controlled by the control chip IC.

As shown in FIG. 12B, in another embodiment, the touch electrodes of the in-cell mutual-capacitive touch panel 12B includes first direction electrodes E1 and second direction electrodes E2, and the first direction and the second direction are interlaced. Wherein, each of the first direction electrodes E1 is divided into electrode regions E11˜E13 and vertically interlaced with the second direction electrodes E2.

It should be noticed that the traces W11˜W13 of the different electrode regions E11˜E13 of the first direction electrode E1 are connected to the control chip IC out of the active area TPAA of the in-cell mutual-capacitive touch panel 12B independently, and each second direction electrode E2 is connected to the control chip IC through its independent trace W2, and the touch signals are controlled by the control chip IC. The difference between FIG. 12A and FIG. 12B is that the traces W11˜W13 of the different electrode regions E11˜E13 of the first direction electrode E1 are connected by the same lateral trace (L1˜L3) out of the active area TPAA of the in-cell mutual-capacitive touch panel 12B and then connected to the control chip IC. This lateral trace (L1˜L3) can be any conductive layer (e.g., M1 or M2) originally disposed in the TFT layer, but not limited to this.

After lateral connections are formed, the independent trace W11 of each electrode region E11, the independent trace W12 of each electrode region E12, and the independent trace W13 of each electrode region E13 can be connected to the control chip IC in a form of multiple groups (as shown in FIG. 12B), or only independent trace (e.g., W11) of certain electrode region (e.g., E11) are connected to the control chip IC in a form of one group (as shown in FIG. 112C). It can be adjusted based on practical needs to achieve multi-driving function.

Compared to the prior arts, the in-cell touch panel and its trace layout of the invention have following advantages:

(1) Designs of the touch electrodes and their traces in the in-cell touch panel of the invention are very simple, and the cost of the in-cell touch panel of the invention can be reduced.

(2) The aperture ratio of the LCD touch panel will not be affected by the novel trace layout method of the invention.

(3) The RC loading of the common electrode can be reduced.

(4) When the in-cell touch panel is operated in the touch mode, the common electrode is controlled simultaneously to reduce the entire RC loading of the in-cell touch panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An in-cell touch panel, comprising:
a plurality of pixels, a laminated structure of each pixel comprising:
a substrate;
a thin-film transistor layer disposed above the substrate, wherein a first conductive layer and a common electrode are disposed in the thin-film transistor layer, and the first conductive layer is arranged in mesh type;
a liquid crystal layer, disposed above the thin-film transistor layer;
a color filtering layer, disposed above the liquid crystal layer; and
a glass layer, disposed above the color filtering layer.

2. The in-cell touch panel of claim 1, wherein the in-cell touch panel is an in-cell mutual-capacitive touch panel, and touch electrodes of the in-cell mutual-capacitive touch panel are formed by the first conductive layer which is arranged in mesh type, the touch electrodes comprise a first direction electrode and a second direction electrode.

3. The in-cell touch panel of claim 2, wherein the first direction electrode and the second direction electrode of the touch electrodes are interlaced each other to increase an area of an effective touch region.

4. The in-cell touch panel of claim 2, wherein area division of the touch electrodes is determined according to connection or disconnection of the first conductive layer.

5. The in-cell touch panel of claim 2, wherein a part of the first conductive layer not forming the touch electrodes is disposed in a vacancy region between the touch electrodes to connect with the common electrode.

6. The in-cell touch panel of claim 1, wherein the first conductive layer is formed after the common electrode.

7. The in-cell touch panel of claim 1, wherein the first conductive layer is formed before the common electrode.

8. The in-cell touch panel of claim 1, wherein the color filtering layer comprises a color filter and a black matrix resist and the black matrix resist has good light resistance, and the first conductive layer is disposed under the black matrix resist.

9. The in-cell touch panel of claim 2, wherein a second conductive layer is also disposed in the thin-film transistor layer and the second conductive layer is formed before the first conductive layer and the common electrode.

10. The in-cell touch panel of claim 9, wherein the second conductive layer and the common electrode are connected to decrease resistance.

11. The in-cell touch panel of claim 9, wherein the second conductive layer and a gate electrode of the thin-film transistor layer are formed simultaneously.

12. The in-cell touch panel of claim 11, wherein the gate electrode of the thin-film transistor layer is arranged adjacent to another gate electrode.

13. The in-cell touch panel of claim 9, wherein the second conductive layer and the first conductive layer are overlapped and connected in parallel to decrease resistance.

14. The in-cell touch panel of claim 9, wherein the second conductive layer and a source electrode and a drain electrode of the thin-film transistor layer are formed simultaneously.

15. The in-cell touch panel of claim 9, wherein when the laminated structure has a half source driving (HSD) structure, the laminated structure has an additional space which is originally occupied by a source line.

16. The in-cell touch panel of claim 15, wherein the second conductive layer is disposed in the additional space to be traces of the touch electrodes.

17. The in-cell touch panel of claim 15, wherein the second conductive layer is disposed in the additional space to connect with the common electrode to decrease resistance.

18. The in-cell touch panel of claim 16, wherein the traces of the touch electrode are arranged in a centralized way or a uniform way.

19. The in-cell touch panel of claim 2, wherein at least one multi-function electrode (MFL) is disposed between the first direction electrode and the second direction electrode of the touch electrodes.

20. The in-cell touch panel of claim 2, wherein a shape of the touch electrode is arbitrary geometries.

21. The in-cell touch panel of claim 2, wherein an edge of the touch electrode is irregular.

22. The in-cell touch panel of claim 1, wherein when the in-cell touch panel is operated in a touch mode, the common electrode is switched to a floating voltage level or provided a touch-related signal.

23. The in-cell touch panel of claim 1, wherein when the in-cell touch panel is operated in a touch mode, a source line is switched to a floating voltage level or provided a touch-related signal.

24. The in-cell touch panel of claim 1, wherein a touch mode and a display mode of the in-cell touch panel are driven in a time-sharing way, and the in-cell touch panel is operated in the touch mode during a blanking interval of a display period of the in-cell touch panel.

25. The in-cell touch panel of claim 24, wherein the blanking interval comprises at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval comprises the vertical blanking interval.

26. The in-cell touch panel of claim 2, wherein the first direction electrode is divided into electrode regions and vertically interlaced with the second direction electrode.

27. The in-cell touch panel of claim 26, further comprising:
a driving chip disposed out of an active area (AA) of the in-cell touch panel.

28. The in-cell touch panel of claim 27, wherein the traces of different electrode regions of the first direction electrode are connected to the driving chip independently.

29. The in-cell touch panel of claim 27, wherein traces of at least two electrode regions of the first direction electrode are connected out of the active area of the in-cell touch panel and then connected to the driving chip.

30. The in-cell touch panel of claim 29, wherein the traces of the at least two electrode regions of the first direction electrode are connected out of the active area of the in-cell touch panel by an original conductive layer of the thin-film transistor layer.

31. The in-cell touch panel of claim 29, wherein the traces of the at least two electrode regions of the first direction electrode are connected out of the active area of the in-cell touch panel and then connected to the driving chip in a form of one group or multiple groups.
